(19) United States
(12) Patent Application Publication
(10) Pub. No.: US 2013/0304565 A1
(43) Pub. Date: Nov. 14, 2013

(54) SYSTEM AND METHOD FOR ADVERTISING ON MOBILE PLATFORMS

(71) Applicant: Rodolfo Saccoman, Miami Beach, FL (US)

(72) Inventor: Rodolfo Saccoman, Miami Beach, FL (US)

(73) Assignee: ADMOBILIZE LLC., Miami Beach, FL (US)

(21) Appl. No.: 13/851,970

(22) Filed: Mar. 28, 2013

Related U.S. Application Data
(60) Provisional application No. 61/645,940, filed on May 11, 2012.

(51) Int. Cl. G06Q 30/02

(52) U.S. Cl. CPC G06Q 30/0242
USPC 705/14.41

(57) ABSTRACT

An advertising system comprising a mobile platform associated with an exhibitor and used to exhibit a selected ad of an advertiser and to obtain tracking data related to the selected ad, a server for processing the tracking data into desired metrics and for providing the desired metrics to the advertiser and/or the exhibitor, and an administrator for administering actions by the exhibitor and by the advertiser and for approving and paying the exhibitor. The mobile platform may be a car or a tablet computer. In a method of use, the administrator receives and approves a request from a person to be an exhibitor of a selected ad on a respective exhibitor mobile platform, provides the exhibitor with means to exhibit the selected ad and to provide real time tracking data related to the selected ad, and receives and optionally processes the tracking data into metrics data provided to the advertiser and optionally to the exhibitor. The exhibitor is then paid by the administrator according to a predetermined arrangement.

### CROSS REFERENCE TO RELATED APPLICATIONS

This application is related to and claims priority from U.S. Provisional Patent Application No. 61/645,940 having the same title and filed May 11, 2012, which is incorporated herein by reference in its entirety.

### FIELD

Embodiments of the invention relate generally to advertising on mobile platforms and more particularly to advertising on mobile tablet computers (“tablets”) and cars or other vehicles.

### BACKGROUND

Advertising on mobile platforms (e.g. on vehicles) is known, see e.g. US patent application 20090299857 which teaches ads “requested” by an electronic device on one mobile platform or another. All such requests and completed deliveries are confirmed as they occur and are logged for later downloading. Integral measurements reveal the content viewed, precisely where it was viewed (based on GPS data), when and by whom it was viewed (in significant demographic detail), and for exactly how long. The system also documents whether or not any impulse information was requested or if any purchases were made as a result of the viewing. Finally, the system can then track geographic movements on the part of mobile platforms after content viewings to confirm local area effectiveness—for example driving to a specific hotel or restaurant immediately after seeing an ad for it. Furthermore, every content request, whether or not it resulted in a confirmed delivery, is recorded in the hard drive of every involved mobile platform. However, neither this nor any other known reference dealing with mobile advertising teaches having an ad exhibitor request to join a system in which he/she can select a particular ad of an ad campaign of a particular advertiser for display on his/her mobile platform. No known reference teaches using the moving platform to acquire real time tracking data related to the particular ad displayed on the mobile platform. No known reference teaches using a mobile platform to transmit the tracking data and other information in real time to a remote server for processing into metrics, which are provided in real time to an advertiser.

There is therefore a need for, and it would be advantageous to have, methods and systems for advertising on a mobile platform associated with a particular exhibitor, while acquiring real time ad viewing tracking data using acquisition equipment on the mobile platform, processing such real time tracking data into desired metrics and supplying the desired metrics in real time to the particular advertiser as well as to a system administrator and to the particular exhibitor.

### SUMMARY

In an embodiment there is provided an advertising system (named “AdMobilize”) comprising a mobile platform (a car or another type of vehicle, or a tablet associated with an exhibitor (referred to hereinafter as an “AdMobilizer”) and used to exhibit a selected ad of an Advertiser and to obtain real time tracking data related to the selected ad, a server for processing the tracking data into desired metrics and for providing the metrics to the Advertiser and/or the AdMobilizer, and an Administrator for running the system and for approving and paying the AdMobilizer. Henceforth, “car” is used to represent all types of vehicles. The tracking data is obtained using tracking data acquisition means attached to, or integral to the moving platform (such means referred to henceforth simply as “beacon”). A beacon disclosed herein can capture and communicate in real time tracking data including demographics, traffic, routing, GPS location coordinates, still images and/or video images of actual people faces (“eyeball tracking”) and of vehicles viewing a particular selected ad, face counts, car and other vehicle counts, time stamps (day, time, year), a beacon identifier (ID), an ad insert ID, and management logistics. The tracking data is pushed to the server, where it is processed into desired metrics. The metrics are then provided (for example for visual display) to the AdMobilizer, Advertiser and Administrator via respective AdMobilizer, Advertiser, and Administrator portals.

The AdMobilizer is paid by the Administrator, which is paid in return by the Advertiser. The AdMobilizer is paid based on a “pledge” to participate in an ad campaign. The AdMobilizer sees all available ad campaigns and pledges to advertise a chosen ad of a particular campaign. If the ad chosen is a car ad, the AdMobilizer may be paid a monthly fee to drive the car. If the ad chosen is a tablet ad, the AdMoblizer carrying the table may be paid based on the actual time spent carrying the tablet. Other payment schemes are also possible.

In an embodiment, there is provided an advertising method comprising the steps of: by a system administrator: receiving and approving a request from a person to be an exhibitor of a selected ad on a respective exhibitor car; providing the exhibitor with a car ad display for displaying the selected ad and with a beacon for acquiring real time tracking data related to the selected ad; receiving the tracking data from the beacon; optionally, processing the tracking data into metrics data; and providing at least some of the tracking data or the metrics data to the advertiser.

In an embodiment, there is provided an advertising method comprising the steps of: by a system administrator: receiving and approving a request from a person to be an exhibitor of a selected ad on a respective exhibitor tablet computer which includes tracking data acquisition means; receiving from the tracking data acquisition means real time tracking data related to the selected ad; optionally, processing the tracking data into metrics data; and providing at least some of the tracking data or metrics data to the advertiser.

In an embodiment, the method further comprises the step of paying the exhibitor for displaying the selected ad.

### BRIEF DESCRIPTION OF THE DRAWINGS

Non-limiting embodiments are herein described, by way of example only, with reference to the accompanying drawings, wherein:

FIG. 1 shows in a flow chart an embodiment of a method for advertising on mobile platforms disclosed herein;

FIG. 2a shows schematically an embodiment of a system for advertising on mobile platforms disclosed herein;

FIG. 2b shows a simulated view of a car with a car ad display and beacon in a rear car window;

FIG. 2c shows a simulated view of an AdMobilizer with a tablet on their back displaying a specific ad campaign;

FIG. 3 shows schematically details of a car ad display;

FIG. 4 shows schematically a more detailed view of a beacon;

FIG. 5 shows a tablet displaying an ad and target demographics selected by an Advertiser for the AdMobilizer.

### DETAILED DESCRIPTION

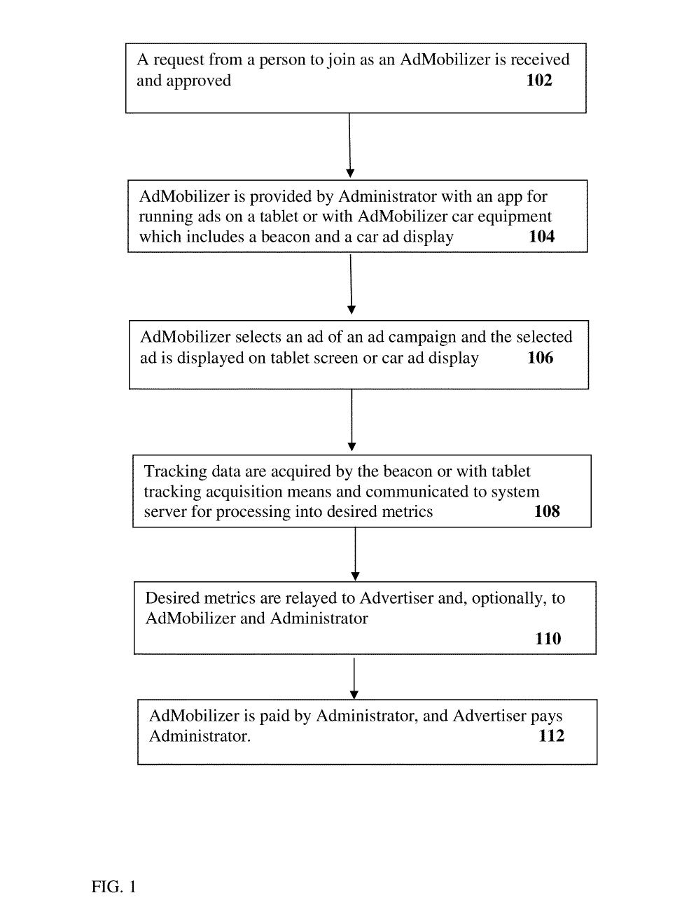

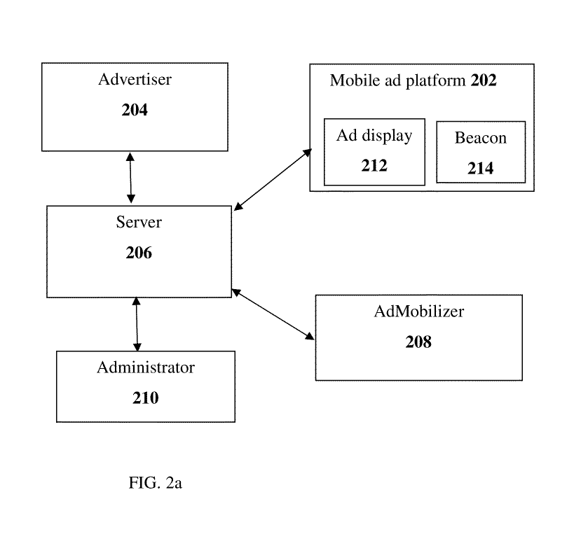

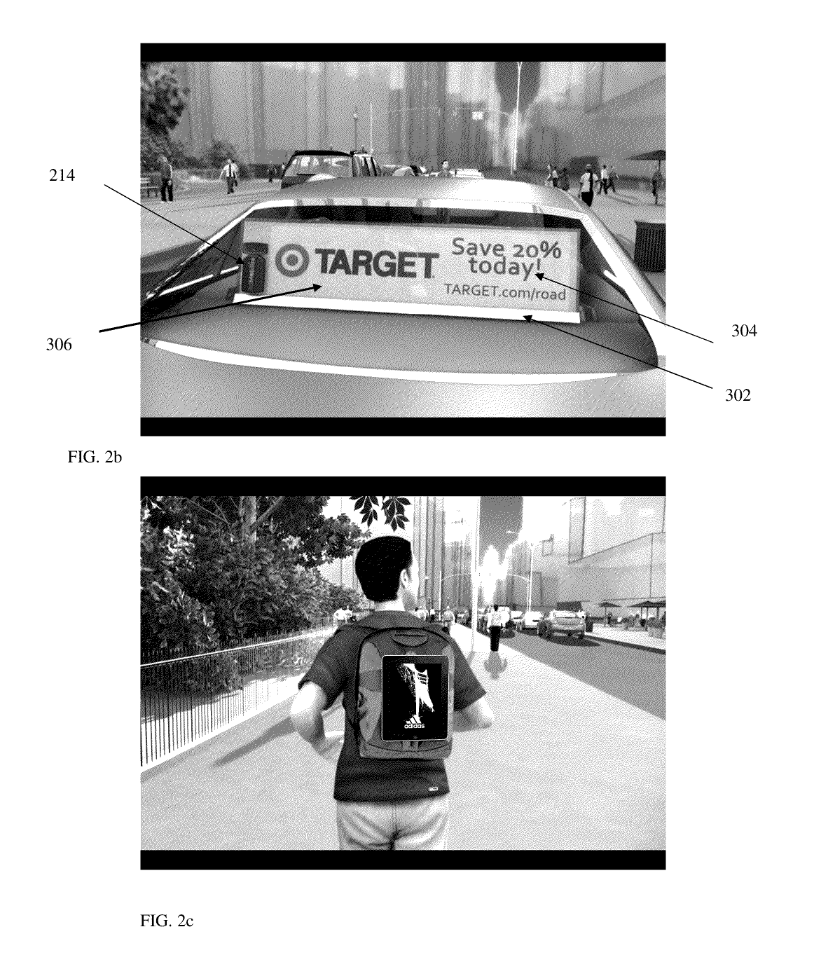

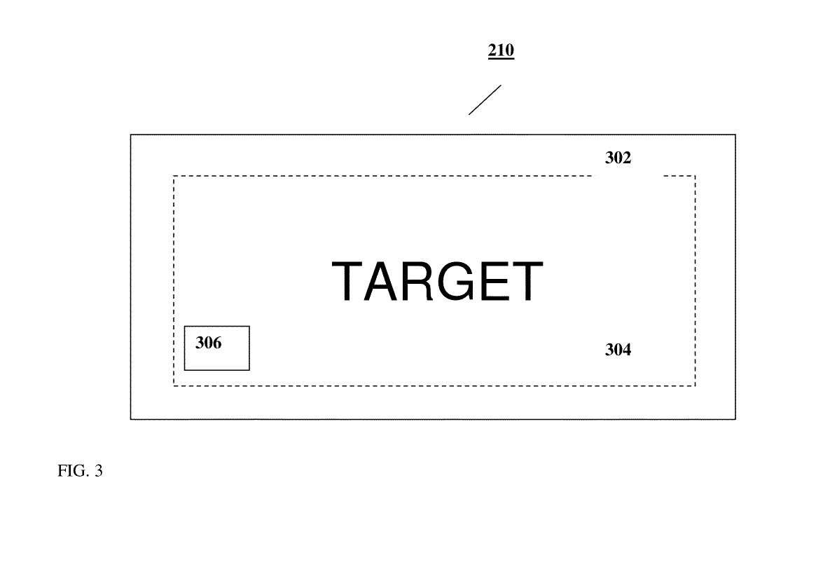

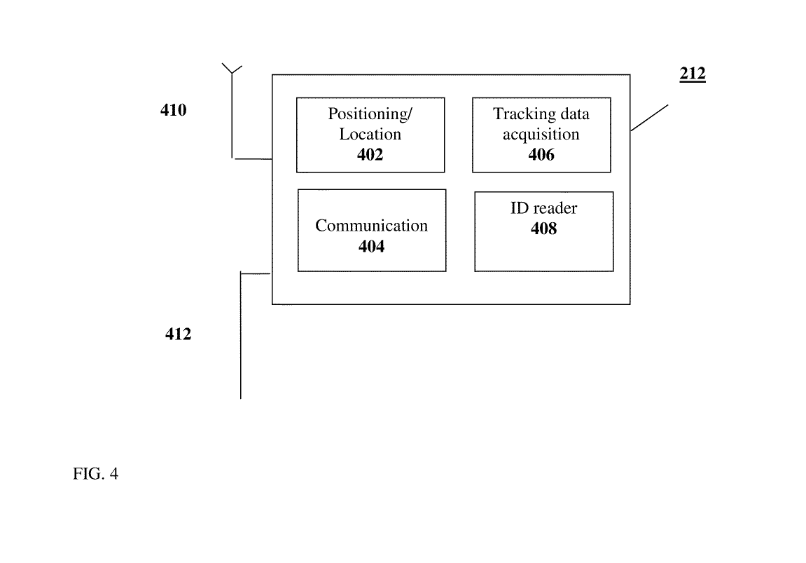

FIG. 1 shows in a flow chart an embodiment of a method for advertising on mobile platforms disclosed herein. The method is exemplarily performed by a system shown in FIG. 2. A person applies (signs up) to become an exhibitor (AdMobilizer). The AdMobilizer has a mobile platform associated (owned, rented, etc.) therewith. The mobile platform may exemplarily be a tablet, a car or another type of vehicle, for example a bus, taxi, bicycle, motorcycle, etc. For simplicity, the description continues with exemplary reference to tablets and cars as mobile platforms, with the understanding that it applies equally well to other mobile platforms. A system Administrator receives and approves a request from the person to join as an AdMobilizer in step 102. The person is thus “accepted” by the Administrator as an AdMobilizer. The acceptance procedure includes registration of his/her car and other information (for example license number, car type, driver license number, insurance details, etc.) or tablet information, and registration of personal demographic details. After acceptance, in step 104, the AdMobilizer is provided with AdMobilizer car equipment (i.e. ad exhibition and tracking equipment) for installation in his/her car, or with a tablet application (“app”) for running ads on a tablet. The app is activated every time a chosen add is to be run. The car equipment includes an ad holder, a beacon and an ad insert (i.e. the ad itself) tagged with an ad identifier, the two together referred to as “car ad display”, see also description of FIGS. 3 and 4. Each ad insert is tagged with a unique ad identifier. The ad identifier may be a RFID chip, an optical identifier such as a barcode, a number, a symbol, an alphanumeric string, or any other electronic or optical identifier that can identify uniquely the ad insert. The ad identifier is readable by the beacon. The AdMobilizer then selects an ad from a number of ad campaigns. For example, various ad campaigns may be seen by him/her on an AdMobilizer portal coupled to the system server (see below). The ad campaign selection may be based on advertiser needs. Exemplary needs are listed and discussed in the portal examples below.

After selection by the AdMobilizer of an ad campaign of a particular Advertiser from a number of ad campaigns presented to him/her, a selected ad of the campaign is run on an exhibition platform (tablet screen or car ad display) in step 106. In the case of a tablet, the ad display is the tablet screen. The tablet has position/location, tracking data acquisition and communication capabilities referred to in more detail below. The selected ad is then shown to viewers. Ad session tracking data is acquired by the beacon (for a car) or by tablet tracking means (for a tablet), and communicated to the system server in step 108. Exemplary tracking data may include GPS data, coordinates; time (of the selected ad being displayed), the route over which the selected ad is displayed, images photographed and/or video recorded by the beacon or tablet camera, and vehicle and/or people counts. The tracking data may be sent “raw” or may be processed into desired metrics before relay to the particular Advertiser and, optionally, to the AdMobilizer and to the Administrator in step 110. Typically, both Advertiser and AdMobilizer receive the metrics for display on their respective portal. In step 112, the AdMobilizer is paid by the Administrator for running the ad campaign, while the Advertiser pays the Administrator.

FIG. 2a shows schematically an embodiment 200 of a system for advertising on mobile platforms disclosed herein. System 200 includes a mobile platform 202 associated with an AdMobilizer and used to exhibit an ad associated with an Advertiser 204 and chosen by the AdMobilizer and to obtain tracking data related to the ad. The tracking data may be associated with an advertising “session” defined by a time period. As indicated above, the mobile platform may exemplarily be a car or a tablet. Platform 202 includes a car ad display 212 for displaying the ad chosen by the AdMobilizer and a beacon 214 for obtaining the tracking data. If a car, platform 202 is wirelessly coupled to a system server 206, which is further communicatively coupled to an AdMobilizer portal 208 and to an Administrator portal 210. In case of a car or similar vehicle, the car ad display is positioned in an area visible to other drivers or pedestrians. In an embodiment, the car ad display is mounted on or in the general vicinity of a rear window, to be viewable by cars and drivers positioned behind the mobile platform. In another embodiment, the car ad display is mounted in the general vicinity of a rear side window. The car ad display may be powered by a car battery, by an independent battery, or by another type of power source. The beacon may be physically attached to the car ad display or may be physically separate but in the general vicinity of the car ad display. FIG. 2b shows a simulated AdMobilizer car with an ad displayed in a rear window. FIG. 2c shows a simulated view of an AdMobilizer with a tablet on his/her back, displaying a specific ad. Details of the car ad display and of the beacon are given next.

FIG. 3 shows schematically a more detailed view of car ad display 212. Some of the components mentioned here are also shown in FIG. 2b. Display 212 includes an ad holder 302 dimensioned to physically hold an ad insert 304. Insert 304 may exemplarily be a transparent static ad sticker tagged with an identifier 306. The ad insert is transparent enough (current requirement is ca. 50% transparency) so as not to reduce the rear view visibility to the driver below a required level. The ID tag identifies the particular ad insert to the beacon, which communicates with the server. Thus, the server knows when a particular ad is displayed by the particular car.

FIG. 4 shows schematically a more detailed view of a beacon 214. Beacon 214 includes in addition to a position/location module 402, a tracking data acquisition module 404, a communication module 406 and an ID reader 408. Beacon 212 thus includes functionalities that do not exist in known mobile beacons, which provide mainly location data. Module 402 may include any known position locator, e.g. a GPS transceiver or a cellular based locator. Module 404 may include a camera that images and video records the cars or drivers viewing the ad. Module 406 may include cellular or other wireless communication capabilities. In general, the beacon is operative to capture tracking data, for example by (viewing) session. The tracking data may include a beacon ID, a beacon status (e.g. ON, OFF, a status indicating that communication occurs), an ad ID (obtained from the respective ID tag), GPS (or otherwise acquired) coordinates, a time stamp (beginning and end of ad display session), a route over which the ad is displayed, images of cars or people viewing a particular ad over the given session and people or car counts. The tracking data through is communicated by module 406 through an antenna 410 to the system server. The beacon may be powered by the car battery, through a charger and power cable 412, or it may have its own power source (not shown).

In an embodiment, the car ad display may be electronic, e.g. a Samsung Transparent Display. Such displays have currently a transmittance rate of over 20% for a black-and-white type and over 15% for a color type and are expected to improve significantly with time. The car ad display may then be dimensioned so as to provide a required threshold transparency through the rear window of the car. In such embodiments, the ad insert may be an electronic ad. The beacon may then be coupled electronically to the display and may recognize the displayed ad and correlate it with the tracking data.

In the case of a tablet used as a mobile advertising platform, the tablet includes a position/location module 402, a tracking data acquisition module 404 and a communication module 406. Module 404 may be based on an integral table camera and endowed with additional “beacon type” tracking functionalities, or it may be a separate beacon attached to the tablet. Since the tablet displays an electronic ad, it does not require an ID reader for identifying the ad. The AdMobilizer carrying the tablet may also manually record tracking data such as a count of people viewing an ad in a given viewing session.

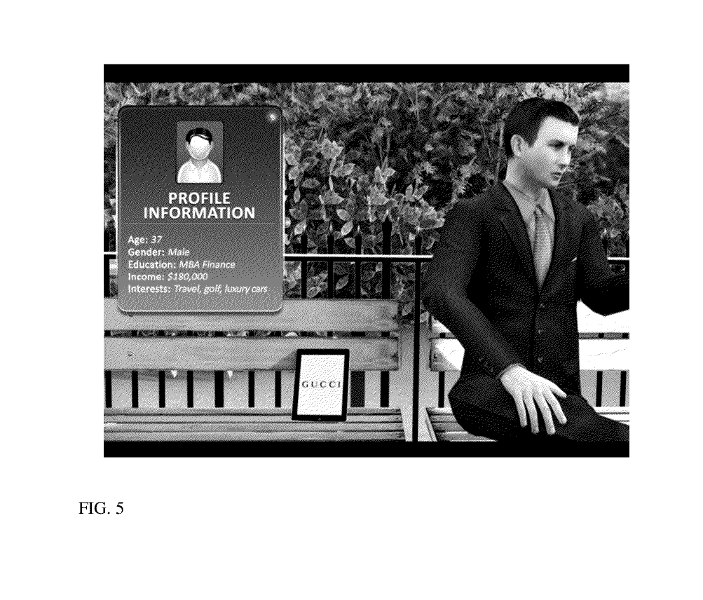

FIG. 5 shows a tablet displaying an ad and target demographics selected by an Advertiser for the AdMobilizer. Exemplarily, in this case the tablet is positioned on a bench next to the AdMobilizer and shows a GUCCI ad.

### Exemplary Admobilize Ad Campaign Cycle

### AdMobilizer and AdMobilizer Portal

In an exemplary procedure, a potential exhibitor (“person”) logs on to the Ad-Mobilizer Portal to learn about the company and about the procedure to become an AdMobilizer. The person may also obtain such information from a search or from ads run on social media or on the Internet. The AdMobilizer Portal may include a description and video of how the system works, and how the potential exhibitor can get paid for being a member. In other words, it shows all the benefits in becoming an AdMobilizer. The person can then register on the portal by providing his/her name, an e-mail address, a password and a zip code. After the initial registration, the system takes the person to a “dashboard”, which exhibits a map of his/her zip code on a background, e.g. a version of Google Maps. The dashboard may exemplarily include the following categories (“sections”):
“Campaigns available”
“History of my latest advertising session”
“Devices”
“Payments”
“My account”
“Refer a friend”
“Offers”
   Additionally, the dashboard may exhibit metrics, statistics, and revenue for the potential exhibitor. This list is by no means limiting, and other categories may be added.

The first time the person visits the portal, a pop-up checklist appears asking exemplarily for the following information:

A. Additional Details: exemplary information supplied by the person on his/her age, gender, marital status, income, household details, typical travel route with various addresses, etc. Accurate information improves the quality of ad campaigns from which he/she can choose an ad.

B. Payments: exemplary information supplied by the person on how he/she prefers to get paid from campaigns. This may include PayPal account information, receiving checks, etc.

C. Devices: exemplary information supplied by the person to register his/her car, tablet or both. For a car, the information may include driver license number, car information, insurance information and personal credit card details as security for the car equipment. For a tablet, the information may include tablet information and profile, and it may be transmitted automatically to the AdMobilize system through a free app downloaded to the tablet. The completion of the information filing procedure may provide the person with a completion percentage of an information list. By completing this list, the person requests to become an AdMobilizer. In return, the person is notified of acceptance as a member.

After acceptance, the AdMobilizer logs on to the portal using a username and a password, and is taken to the “Campaigns” section. The AdMobilizer sees all the available ad campaigns in this section. By “pledging” to a particular ad campaign, the AdMobilizer becomes responsible for displaying an ad of that campaign for a specific Advertiser. Exemplarily, the first time the AdMobilizer logs into the “Campaigns” section, he/she may see that NIKE is seeking an AdMobilizer to display a NIKE ad for three months using his/her car. In return, the AdMobilizer would get paid $100 per month. The AdMobilizer may also see in the “Campaigns” section that CANON is seeking a tablet holder to advertise a CANON ad for 10 hours on a tablet, for which he/she would get paid $70. While other brands may be available in the “Campaigns” section to the AdMobilizer to “pledge” to, he/she decides to choose the NIKE and CANON campaigns. The system may allow an AdMobilizer to represent only a limited number of brands at a time (e.g. 3 brands). As one may only advertise one brand at a time using a car as mobile platform, as the displays in the car are static and as the displays in a tablet are digital, one can run different campaigns on the two mobile platforms. In this example, the AdMobilizer chooses to pledge to the NIKE car campaign and to the CANON tablet campaign. Once the pledge is made for the NIKE car campaign, the system provides the necessary car equipment and an ad insert for for the NIKE campaign, as well as the CANON ad to be downloaded to the tablet.

For the NIKE campaign, the AdMobilizer takes a picture of how the ad looks from behind the car and uploads the picture on his/her AdMobilizer Portal under that campaign. The NIKE campaign is now activated. The AdMobilizer then simply drives the car. The beacon turns on automatically with the car and provides the tracking data. The beacon may take images of what the ad is facing at predetermined time intervals (e.g. every minute) and for predetermined time period. Whenever the AdMobilizer wishes, he/she can log on to the AdMobilizer Portal and see where he/she drove that day as well as obtain metrics of his/her whereabouts. He/she can view the metrics of each one of the individual sessions, can see the amount earned, check reports, see new campaigns, etc. He/she may get exclusive offers from all the brands/partners on the platform.

For the tablet CANON campaign, the AdMobilizer turns on his/her tablet computer and presses an AdMobilize icon to turn on the AdMobilizer app. The system notifies the AdMobilizer of readiness to start displaying the ad (and, if more that one ad is available, which ad). The AdMobilizer then activates the CANON ad. The ad is displayed in all AdMobilizer positions, with the AdMobilizer mobile or stationary. The tablet may track the AdMobilizer's movement, time of display, distance walked, GPS coordinates, etc., and takes images at predetermined time intervals (e.g. every minute) of what the ad is facing. As in the car campaign, whenever the AdMobilizer wishes, he/she can logon to the portal and see where he/she walked that day as well as obtain metrics of his/her whereabouts. He/she can view the metrics of each one of the individual sessions, can see the amount earned, check reports, see new campaigns, etc. He/she may get exclusive offers from all the brands/partners on the platform.

### Advertiser and Advertiser Portal

The Advertiser may exemplarily be an executive of a media company, which also performs media buying. The company works directly with brands trying to convert sales, brand awareness, and other advertising needs such as launch of products, introduction of a new branding messages, etc. The company may be looking for a new disruptive media that could enhance its offerings to its clients. In an exemplary procedure, the executive logs on to the AdMobilizer Portal and completes a very simple form with name, company name, e-mail, and password. This enables the executive (now as “Advertiser”) to log into an Advertiser Portal. The Advertiser Portal may exhibit the main following categories relevant to an Advertiser:
“Dashboard”
“Campaigns”
“Creative”
“Payments”
“Account Management”
“Offers”

This list is by no means limiting, and other categories may be added. The Dashboard takes the Advertiser through a sign-up checklist, in which he/she provide exemplarily company details such as address, phone number, contact information, etc. Then, the dashboard shows the Advertiser on a map all the ways that he/she can segment and select information to create a campaign. Here, a vast list of demographics and psychographics may be available by zip. Parameters such as age, gender, race, marital status, household value, household income, and many others may be presented to allow creation of a sought ad campaign. Advertisers may select campaigns based on predetermined custom clusters of data, demographics and psychographics such as “college students”, “wealthy singles in big cities”, “medium income families that love sports”, etc. (see example in FIG. 5). After selecting a specific campaign, the Advertiser can see how many AdMobilizers are available to showcase his/her specific campaign or ad. From the available AdMobilizers, the Advertiser may segment the one or more who will actually advertise for the company. In an embodiment, a double segmentation is provided to ensure that the Advertiser is really efficient in targeting exactly its campaign requirements. The Advertiser may add available AdMobilizers to a “shopping cart” and may select the periods it wants the campaign to run. For instance, for a car campaign, the Advertiser can select the number of months it wants an ad to be displayed by a particular car. For the tablet option, the Advertiser may select the amount of hours it wants an ad to be displayed. The Advertiser may exemplarily decide on a standard fee per month of car advertising or on an hourly fee for tablet advertising.

The AdMobilize system may provide the Advertiser with averages of what other brands are offering the AdMobilizer in terms of payment. This may help the Advertiser to get the AdMobilizers it wants to advertise its campaigns. Also, the AdMobilize system may allow the Advertiser to request campaigns based on a needed set of segmentation parameters. Even if the Advertiser requests a specific campaign for which there are zero AdMobilizers available, the AdMobilize system and the Administrator will work to recruit AdMobilizers to fulfill the campaign, and will advise the Advertiser when the specific ad campaign can be activated.

In a specific example, an Advertiser has NIKE and CANON as clients. NIKE has requested that the Advertiser invest $40,000 in a new campaign promoting a new NIKE Chicago store about to open, while CANON has requested that the Advertiser invest $20,000 to push CANON's newly launched camera. The Advertiser decides to use AdMobilize to help with this effort. A typical process performed by the Advertiser is as follows:

On the dashboard, the Advertiser selects a car campaign targeting households with annual incomes of between $60,000 and $300,000 in a 10-mile radius from the new NIKE store. The system responds with notification that there 150 car AdMobilizers available for this campaign. The Advertiser decides to further segment the AdMobilizers, by only selecting those (out of the 150) who are women under the age of 45. This yields a revised count of 80 available AdMobilizers. The Advertiser decides to accept the campaign and the system notifies him that the cost per car per month is $500. The Advertiser then adds this campaign to a shopping cart, names the campaign, selects start dates and uploads an actual ad insert file (which will be shipped to car AdMobilizers) to be printed under the “Creative” section. The system then takes the Advertiser to the Payments section, where the Advertiser uploads credit card or other payment means details to pay for this campaign. The Advertiser may then wait until the system advises that all 80 AdMobilizers have received the ad insert and that the campaign is approved and ready to be deployed. At that point, the Advertiser can start tracking and can obtain real-time metrics related to the campaign.

The CANON campaign is run on tablets. The procedure follows closely the one described above, except that the Advertiser chooses exemplarily college students as potential AdMobilizers. The first selection process yields 1,000 AdMobilizers. The Advertiser decides it is willing to pay $10 per hour of advertising for a total budget of $20,000. A further filter leaves only 400 female students on the East Coast as AdMobilizers. The Advertiser approves the campaign, provides and uploads the ad materials and provides payment. The campaign is then pushed to the 400 female tablet holders. The Advertiser waits for them to pledge and the pledged AdMobilizers start showcasing the ads.

A significant benefit of the AdMobilize system for an Advertiser is that the Advertiser can create special offers made available to AdMobilizers. Exemplarily, under the “Special Offers” section, the Advertiser may create an offer for NIKE through which any AdMobilizer that goes to the NIKE store on opening week and prints a coupon available on the system get a 20% off. The Advertiser can also track the results of that coupon redemption. For CANON, the Advertiser may create an online offer where an AdMobilizer clicks on a link to the CANON site, and gets a free case for a camera. The Advertiser can also track the success of this offer.

Further, and even more advantageously, the AdMobilize system provides real time metrics and reporting by specific AdMobilizer and by specific campaign to the Advertiser. The Advertiser may be able to run reports on maps and see each AdMobilizer in real-time, by location on a map. The Advertiser may also be able to see actual images taken by a beacon or tablet camera and the exact surroundings faced by the respective display. The Advertiser may also view all the pictures taken for each specific session, thereby enabling him/her to monitor the accuracy of each campaign and to dispute anything that the Advertiser feels was not done right. An Advertiser may send alerts to those AdMobilizers who do not showcase his/her ads in the way they are supposed to, or may even discontinue a particular AdMobilizer from being part of his/her campaign. Tracking software in a tracking data acquisition module may provide metrics on actual facial counts, eyeball counts or vehicle counts exposed to the ads. This can provide real-time engagement metrics for each session of a campaign, for example, as CPM (cost per thousand) impressions being exposed to people and/or vehicles.

### Tablet Campaign Key Performance Indicators (KPIs)

A. Costing KPIs
a. Spend
   i. Daily
   ii. Weekly
   iii. Monthly
   iv. Lifetime
b. Disputed
   i. Daily
   ii. Weekly
   iii. Monthly
   iv. Lifetime
c. Average Spend
   i. By Campaign
      1. (sum of all campaign spend)/# of campaigns
   ii. By Ad Mobilizer
   iii. By Hour
      1. (sum of all hourly spend)/# number of hours
d. Average Spend Benchmark (across all of AdMobilize
   i. By Campaign
      1. [(sum of all campaign spend)/# of campaigns] across all advertisers
   ii. By AdMobilizer
   iii. By Hour
      1. [(sum of all hourly spend)/# number of hours] across all advertisers

B. Performance KPIs
a. Pledges
   i. Daily
   ii. Weekly
   iii. Monthly
   iv. Lifetime
b. Advertised Hours
   i. Daily
   ii. Weekly
   iii. Monthly
   iv. Lifetime
c. Advertising Sessions
   i. Daily
   ii. Weekly
   iii. Monthly
   iv. Lifetime
d. Reach/Range
   i. Avg Miles
   ii. Max Range
   iii. Total Range
e. Benchmarks against above KPI's

### Vehicle Campaign KPIs

### Heading

A. Costing KPIs
a. Spend
   i. Monthly
   ii. Lifetime
b. Disputed
   i. Monthly
   ii. Lifetime
c. Average Spend
   i. By Campaign
      1. (sum of all campaign spend)/# of campaigns
   ii. By AdMobilizer
   iii. By Hour
      1. (sum of all hourly spend)/# number of hours
d. Average Spend Benchmark (across all of AdMobilize
   i. By Campaign
      1. [(sum of all campaign spend)/# of campaigns] across all advertisers
   ii. By AdMobilizer
   iii. By Hour
      1. [(sum of all hourly spend)/# number of hours] across all advertisers

B. Performance KPIs
a. Pledges
   i. Monthly
   ii. Lifetime
b. Advertised Hours
   i. Daily
   ii. Weekly
   iii. Monthly
   iv. Lifetime
c. Advertising Sessions
   i. Daily
   ii. Weekly
   iii. Monthly
   iv. Lifetime
d. Reach/Range
   i. Monthly
   ii. Lifetime
   iii. Defined by all users registered within the same home zip code.
      1. Average Reach
         a. [(sum of all miles covered by users)/#of users]
      2. Max Range
         a. linear distance between the two furthest AdMobilizers in a campaign.
      3. Total Reach
   iv. (sum of all miles covered by users)

### Administrator and Administrator Portal

The Administrator Portal allows the owners and management of AdMobilize to control both the AdMobilizer Portal and the Advertiser Portals. The Administrator Portal enables to view all ongoing campaigns by client (Advertiser) and all activity by AdMobilizer. The Administrator Portal oversees everything and is the main business management tool to manage the business, collect revenues and manage costs. It exemplarily exhibits the following main categories:
“Dashboard”
“Campaigns”
“Inventory”
“Users” (both AdMobilizers and Advertisers)
“Referrals”
“Finance” (i.e. payments and credit card management)
   “Production and material logistics”—i.e. management of statistics displays to be created and tagged with the RFID label, overall shipping, beacon management, displays, suctions cups, packaging, etc. This list is by no means limiting, and other categories may be added.

While this disclosure has been described in terms of certain embodiments and generally associated methods, alterations and permutations of the embodiments and methods will be apparent to those skilled in the art.

1. An advertising system comprising:
a) a mobile platform associated with an exhibitor and used to exhibit a selected ad of an advertiser and to obtain tracking data related to the selected ad;
b) a server for processing the tracking data into desired metrics and for providing the desired metrics to the advertiser and/or the exhibitor; and
c) an administrator for administering actions by the exhibitor and by the advertiser and for approving and paying the exhibitor.

2. The system of claim 1, wherein the mobile platform is a car.

3. The system of claim 1, wherein the mobile platform is a tablet computer.

4. The system of claim 2, wherein the mobile platform includes a car ad display for displaying the selected ad and a beacon for acquiring the tracking data and for transmitting the tracking data to the server.

5. The system of claim 4, wherein the car ad display includes an ad holder and an ad insert tagged with a unique ad identifier (ID) and wherein the beacon includes a tracking data acquisition module and an ID reader for reading the ad identifier.

6. The system of claim 5, wherein the tracking data acquisition module is operative to acquire viewer counts over an ad viewing session.

7. The system of claim 5, wherein the beacon further includes a position/location module for tracking locations in which the selected ad is viewed and a communication module for communicating with the server.

8. The system of claim 5, wherein the ad insert is non-electronic.

9. The system of claim 8, wherein the non-electronic ad insert is at least 50% transparent.

10. The system of claim 4, wherein the ad insert is electronic.

11. The system of claim 2, wherein the tracking data is selected from the group consisting of a beacon ID, a beacon status, an ad ID, a location or position, a time stamp, a display route, images of cars, images of people viewing the selected ad over a predetermined time period, people or car counts and a combination thereof.

12. An advertising method comprising the steps of: by a system administrator:
a) receiving and approving a request from a person to be an exhibitor of a selected ad on a respective exhibitor car;
b) providing the exhibitor with a car ad display for displaying the selected ad and with a beacon for acquiring real time tracking data related to the selected ad;
c) receiving the tracking data from the beacon;
d) optionally, processing the tracking data into metrics data; and
e) providing at least some of the tracking data or the metrics data to the advertiser.

13. The method of claim 12, further comprising the step of providing at least some of the tracking data or the metrics data to the exhibitor.

14. The method of claim 12, further comprising the step of:
e) paying the exhibitor for displaying the selected ad.

15. The method of claim 12, wherein the car ad display includes an ad holder and an ad insert tagged with a unique ad identifier (ID) and wherein the beacon includes a tracking data acquisition module and an ID reader for reading the ad identifier

16. An advertising method comprising the steps of: by a system administrator:
a) receiving and approving a request from a person to be an exhibitor of a selected ad on a respective exhibitor tablet computer which includes tracking data acquisition means;
b) receiving from the tracking data acquisition means real time tracking data related to the selected ad;
c) optionally, processing the tracking data into metrics data; and
d) providing at least some of the tracking data or metrics data to the advertiser.

17. The method of claim 16, further comprising the step of providing at least some of the tracking data or the metrics data to the exhibitor.

18. The method of claim 16, further comprising the step of:
e) paying the exhibitor for displaying the selected ad.
